(19) United States
(12) Patent Application Publication
(10) Pub. No.: US 2025/0211022 A1
(43) Pub. Date: Jun. 26, 2025

(54) Power Control Apparatuses and Systems

(71) Applicant: DMN Corporation, Austin, TX (US)

(72) Inventors: Clint BORCHGARDT, Austin, TX (US); David NEWBERGER, Austin, TX (US)

(21) Appl. No.: 18/945,726

(22) Filed: Nov. 13, 2024

Related U.S. Application Data
(60) Provisional application No. 63/614,734, filed on Dec. 26, 2023.

(51) Int. Cl. H02J 13/00

(52) U.S. Cl. CPC H02J 13/0005; H02J 13/00002; H02J 13/00024; H02J 13/00026; H02J 2310/14; H02J 2310/64

(57) ABSTRACT

An apparatus for controlling a supply of power to an electrical device. The apparatus comprises an electrical flow path configured to be disposed between a source of electricity and an electrical subsystem of the electrical device. The electrical flow path can be configured to selectively provide a flow electricity from the source to the electrical subsystem based on a power switching message originating from a location remote from the electrical device. The apparatus further comprises a communication interface configured to receive the power switching message, memory for storing instructions, and a processor connected to the memory and the communication interface. The processor can be configured to the memory and the communication interface, wherein the processor is configured to execute the instructions to control the flow of electricity through the electrical path based on the power switching message.

### CROSS-REFERENCE TO RELATED APPLICATIONS

This application claims the benefit of U.S. Provisional Application No. 63/614,734 filed on Dec. 26, 2023, which is hereby incorporated by reference in its entirety.

### BACKGROUND

### Technical Field

Novel aspects of the present disclosure relate to the field of electrical power supply and more particularly to apparatuses and systems for controlling power supply.

### Description of Related Art

It is common for consumers to purchase products, particularly expensive products, from providers on credit. For example, consumers typically purchase automobiles, electronics, and appliances from providers on credit, paying off the outstanding balance on an agreed timeframe. Unfortunately, some consumers do not make these payments, resulting in unpaid use of the products as the providers cannot easily recover the products. Therefore, a need exists for providers to easily terminate the operation of these unpaid products.

### BRIEF SUMMARY

Novel aspects of the present disclosure are directed to an apparatus for controlling a supply of power to an electrical device. The apparatus comprises an electrical flow path configured to be disposed between a source of electricity and an electrical subsystem of the electrical device. The electrical flow path can be configured to selectively provide a flow electricity from the source to the electrical subsystem based on a power switching message originating from a location remote from the electrical device. The apparatus further comprises a communication interface configured to receive the power switching message, memory for storing instructions, and a processor connected to the memory and the communication interface. The processor can be configured to the memory and the communication interface, wherein the processor is configured to execute the instructions to control the flow of electricity through the electrical path based on the power switching message.

In another aspect, the present disclosure is directed to an apparatus comprising an appliance and a power control device. The appliance includes an electrical subsystem. The power control device comprises an electrical flow path disposed between a source of electricity and the electrical subsystem, a communication interface configured to receive the power switching message, memory for storing instructions, and a processor connected to the memory and the communication interface. The electrical flow path can be configured to selectively provide a flow electricity from the source to the electrical subsystem based on a power switching message originating from a location remote from the apparatus. The processor can be configured to execute the instructions to control the flow of electricity through the electrical path based on the power switching message.

In yet another aspect, the present disclosure is directed to a system for managing power supply to an appliance. The system includes an appliance having an electrical subsystem, a power control device electrically coupled between the electrical subsystem of the appliance and a source of electricity, and a processor in communication with the power control device via a network. The power control device can be configured to selectively provide a flow electricity from the source to the electrical subsystem based on receiving a power switching message originating from a location remote from the appliance. The processor can be configured to maintain a database comprising a customer payment status associated with the appliance and transmit a notification to a remote device when the customer payment status is delinquent.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts an embodiment of a simplified power control device for controlling a supply of power to an appliance.

FIG. 2A depicts a perspective view of the power control device in FIG. 1.

FIG. 2B depicts a simplified view of the interior of the apparatus in FIG. 1.

FIG. 2C depicts a simplified exploded view of the apparatus in FIG. 1.

FIG. 3A depicts a top view of the interior of a power control device.

FIG. 3B depicts a side view of a portion of the interior of the apparatus in FIG. 3A.

FIG. 4 depicts an embodiment of a system that includes an apparatus configured to control a power supply to an appliance.

FIG. 5 depicts a diagram of example components of one or more devices of FIG. 4.

FIG. 6 is a block diagram of a communications device for use in controlling a supply of power to an electrical device according to an illustrative embodiment.

### DETAILED DESCRIPTION

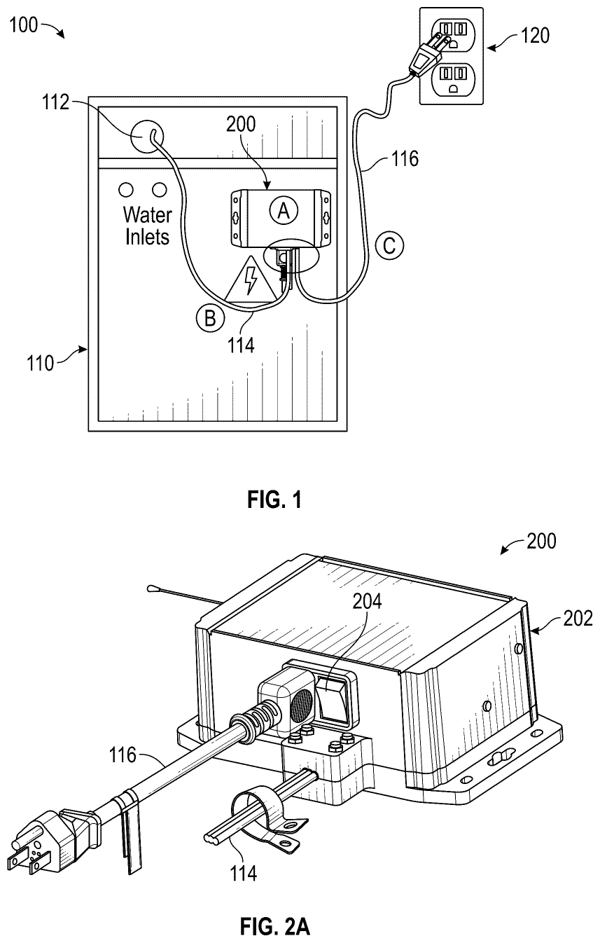

FIG. 1 depicts an embodiment 100 of a simplified power control device (or apparatus) 200 for controlling a supply of power to an appliance 110. Appliance 110 includes a power interface 112 that is configured to receive a first end of electrical power cord 114. Power control device 200 configured to control the supply of power to the appliance 110 is installed in an electrical flow path between the appliance 110 and a source 120 of the supply of power. Power control device 200 includes a first power interface (not shown) that is configured to receive a second end of electrical power cord 114. Power control device 200 also includes a second power interface (not shown) that is configured to receive a first end of electrical power cord 116, with the second end of electrical power cord 116 being connected to the source 120 of the supply of power.

Power control device 200 can be installed into or on appliance 110 at a location that is inaccessible or not easily accessible to users of the appliance 110. In the illustrative embodiment in FIG. 1, the power control device 200 is installed onto the rear panel (or backside) of the appliance 110, but can be installed inside or underneath the appliance 110. In the illustrated embodiment, power control device 200 includes water inlets 150 (e.g., a washing machine) located in the rear panel. Power control device 200 can be positioned as close to the top of the appliance 110 as possible, but also above water inlets 150 to avoid damage to power control device 200 in the event of a leak from water inlets 150. Additionally, power control device 200 can be oriented with the first power interface and second power interface facing the floor (or surface supporting the appliance) to avoid water exposure. Electrical power cord 114 and electrical power cord 116 can be secured against the rear panel of power control device 200 to dissuade users from disabling power control device 200.

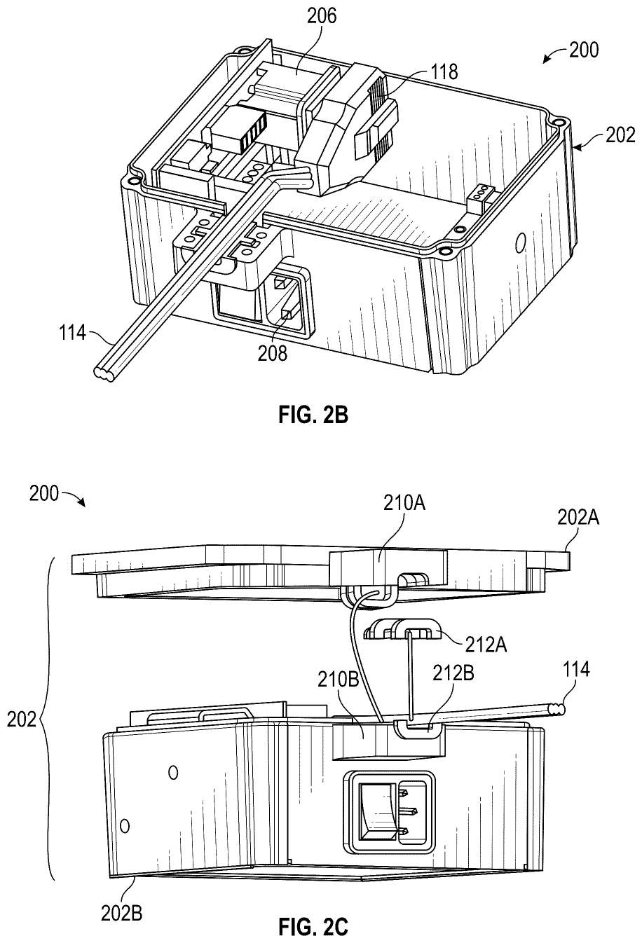

Turning to FIG. 2A-2C, the power control device 200 from FIG. 1 is illustrated in further detail. Power control device 200 includes enclosure 202 that is formed by a lid 202A and a container 202B, which are removably coupled to each other. The interior of enclosure 202, can include a first power interface 206 that is configured to couple to the plug 118 of electrical power cord 114. In the illustrative embodiment, the first power interface 206 is a socket that is configured to receive a power plug. In an alternative embodiment, the first power interface 206 can conductors configured to receive the terminal end of the power cord 114, which can be a bare wire. On the exterior of enclosure 202, power control device 200 includes a second power interface 208 that is configured to couple to electrical power cord 116 and power switch 204.

Power control device 200 includes an aperture 214 formed between lid 202A and container 202B. In the illustrated embodiment, lid 202A includes a protuberance 210A and container 202B includes a corresponding protuberance 210B, with aperture 214 being formed through the protuberances 210A, 210B on the lid 202A and container 202B. The protuberances 210A, 210B may also include grommets (or gasket linings) 212A, 212B that seal the interior of power control device 200 from the environment when electrical power cord 114 is installed therein.

As explained in detail below, power control device 200 can be configured to receive a power switching message from a user (e.g., the owner of appliance 110) to terminate or commence the flow of electricity to appliance 110. Additionally, power control device 200 receiving the power switching message may be in response to various events or actions.

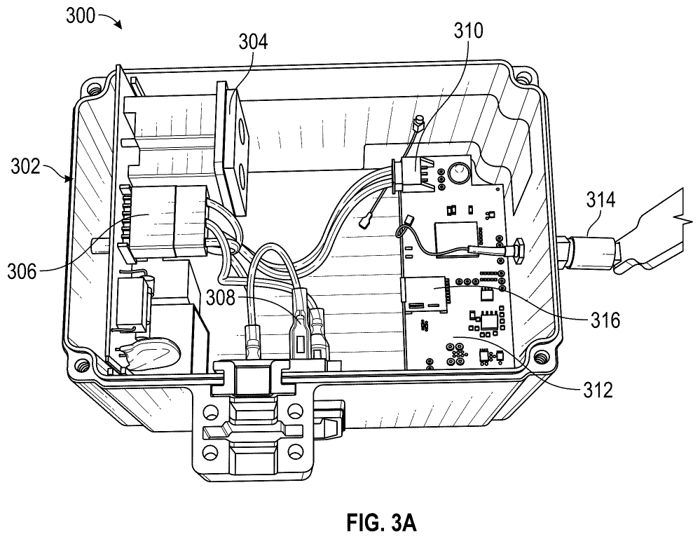

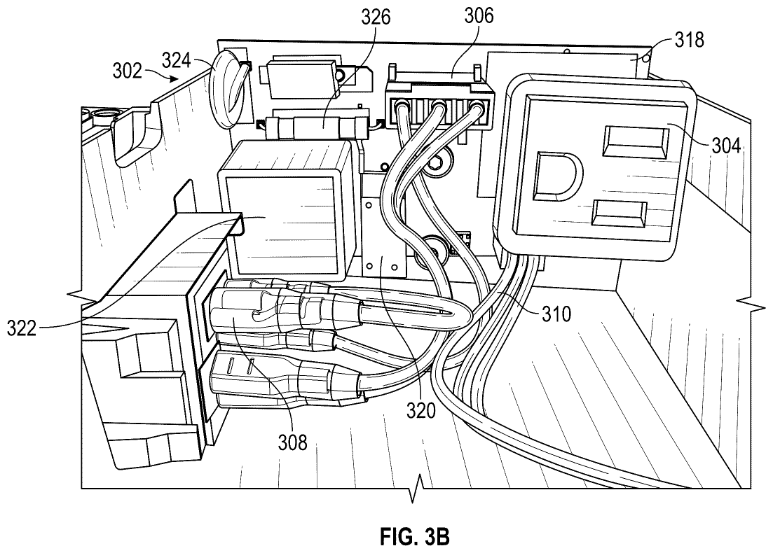

Turning to FIGS. 3A and 3B, a detailed illustration of the components inside enclosure 302 of power control device 300 is shown. Power control device 300 includes a first printed circuit board (PCB) 318 that is electrically coupled to the first power interface 304, relay 320, AC/DC converter 322, a first internal connector 306, fuse 326, and resistor 324. Power control device 300 also includes a second PCB 312 that is electrically connected to a second internal connector 310 and a communication interface. The communication interface may include an antenna 314 and SIM card 316. The first PCB 318 and second PCB 312 are communicatively connected via the second internal connector 310. A wire assembly input 308 is communicatively connected to the first PCB 318 via the first internal connector 306.

Non-limiting examples of the components illustrated in FIGS. 3A and 3B are described as follows. The first power interface 304 can include a PCB outlet with a rating of 15 A and 125V. Relay 320 can include a rating of 10 A and 277 VAC. AC/DC converter 322 can include a rating of 85 VAC-305 VAC (input), 5V (output), and 5 W. The first internal connector 306 is a 3-pin connector having a rating of 15 A and 300V. Fuse 326 can include time lag ceramic fuses with a rating of 2 A and 250V. Resistor 324 can include a metal oxide varistor with a surge current capability of 4500 A. The second internal connector 310 is a 3-pin connector having a rating of 3 A and 250V. The second power interface (not shown) can include a socket having a rating of 10 A and 250 VAC. The second power interface can be configured to couple to a detachable cord set with a rating of 10 A and 125 VAC.

The communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a BLUETOOTH, WIFI, or other such transceiver (not shown). In addition, GPS (Global Positioning System) receiver module may provide additional navigation- and location-related wireless data to device, which may be used as appropriate by applications running on device.

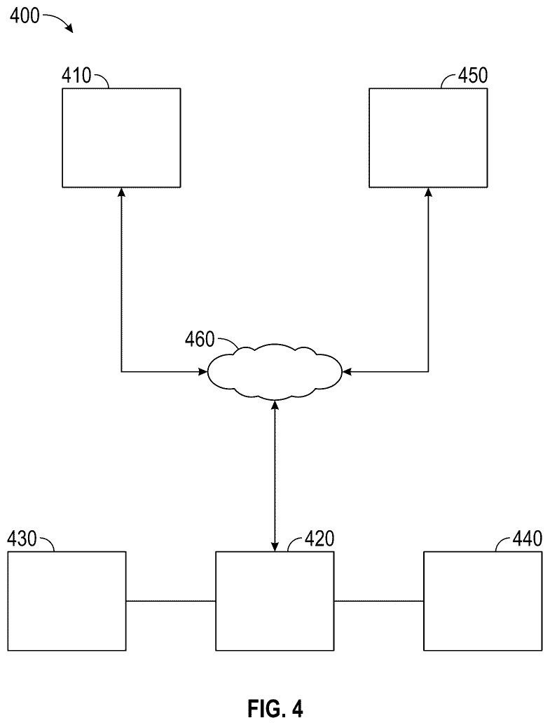

Turning to FIG. 4, a simplified embodiment of a system 400 for controlling a flow of electricity to an appliance is illustrated. System 400 includes an external device 410, a power control device 420 (which is the same or similar power control device 200 in FIG. 2 and 300 in FIG. 3), and a server (or processor) 450. As described above, the power control device 420 can be electrically connected between the electrical subsystem of the appliance 430 and a source of electricity 440.

The server 450 is in communication with the external device 410 and power control device 420 via network 460. Additionally, the power control device 420 can be in communication with the external device 410. System 400 can include a long-term evolution (LTE) system, a 4th generation (4G) system, or a 5th generation (5G) system.

Server 450 is configured to maintain a database of customer information, including customer payment statuses associated with appliances 430. Server 450 is configured to transmit notifications to the external device 410 when the customer payment status associated with the appliance 430 is delinquent. Non-limiting examples of delinquent customer payment statuses include missing the payment due date or having an outstanding balance for a period of time. Examples of the period of time range from one day to six months. Additionally, the server 450 can be configured to transmit the notification within a threshold period of time of the customer payment status becoming delinquent. The threshold period of time can range from about 0 hours (i.e., instantly) to about 72 hours. Upon receiving the delinquency notification, the user of the external device can transmit a power switching message to the power control device 420 to terminate the flow of electricity to the appliance 430. Once the customer payment status is no longer delinquent, server 450 can transmit another notification to the external device 410. Upon receiving the notification, external device 410 can transmit another power switching message to the power control device 420 to commence the flow of electricity to the appliance 430.

In an alternative embodiment, server 450 can also be configured to receive, in response to the notification, a message from the remote device 410 instructing the server to transmit the power switching message to the power control device 420 to terminate the flow of electricity to the appliance 430. Similarly, server 450 can be configured to receive, in response to the second notification, a message from the remote device 410 instructing the server to transmit the power switching message to the power control device 420 to commence the flow of electricity to the appliance 430.

In another embodiment, server 450 can be configured to automatically transmit a power switching message to the power control device 420 to terminate the flow of electricity to the appliance 430 when the customer payment status is delinquent. Server 450 can transmit a notification to the external device 410 prior to, simultaneously with, are subsequent to transmitting the power switching message to terminate the flow of electricity to the appliance 430. Similarly, Server 450 can transmit a notification to the external device 410 prior to, simultaneously with, are subsequent to transmitting the power switching message to commence the flow of electricity to the appliance 430. System 400 may be configured to include multiple external devices, power control devices, or servers.

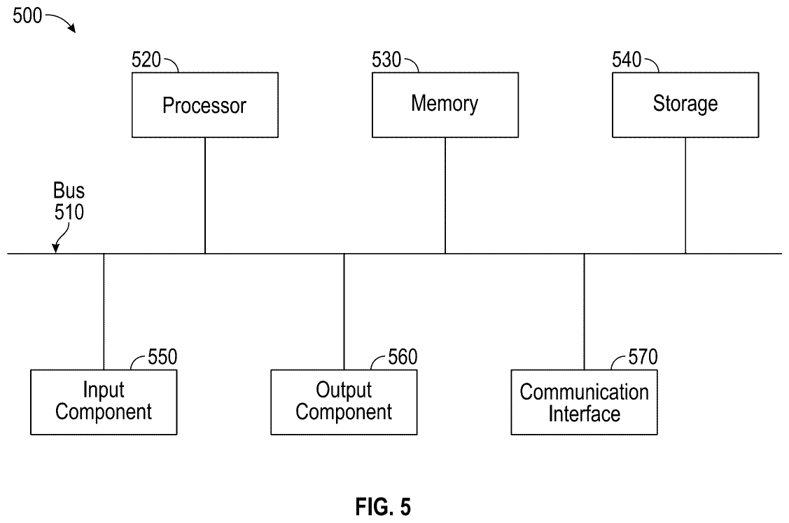

FIG. 5 a block diagram of example components of a device 500 is shown. The device 500 may correspond to the server 450 and/or external devices 410. As shown in FIG. 5, the device 500 may include a bus 510, a processor 520, a memory 530, a storage component 540, an input component 550, an output component 560, and a communication interface 570. Bus 510 includes a component that permits communication among the components of the device 500. Processor 520 is implemented in hardware, firmware, or a combination of hardware and software. The processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 520 includes one or more processors capable of being programmed to perform a function. Memory 530 includes a random-access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 550 includes a component that permits the device 500 to receive information, such as via user input (e.g., a control bar, a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

Device 500 may perform one or more processes described herein. Device 1900 may perform these processes based on the processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

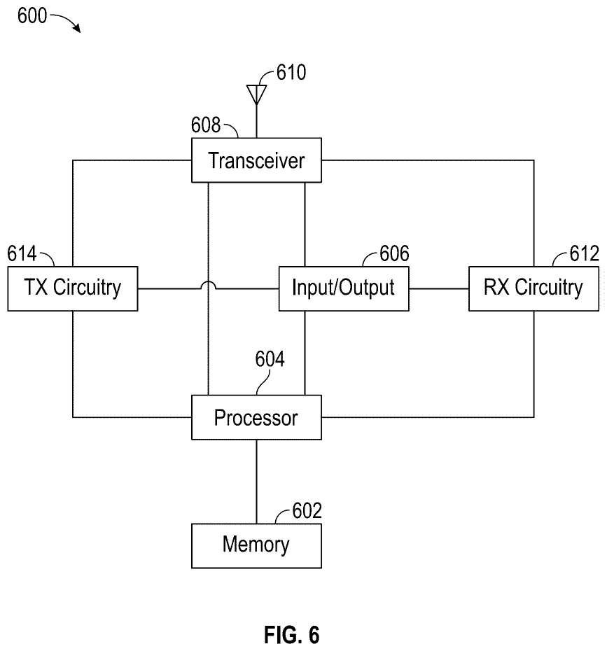

FIG. 6 is a block diagram of a communications device for use in controlling a supply of power to an electrical device, according to an illustrative embodiment. The communications device 600 is provided for illustration only. The external device 410 in FIG. 4 can have the same or similar configuration as the communications device 600.

Communications device 600 includes memory 602 storing instructions that can be executed by processor 604 for controlling the operation of the communications device 600. For example, the memory can store an operating system and one or more applications that can be executed by the processor 604. The memory 602 can include random access memory (RAM), Flash memory, and/or read-only memory (ROM).

I/O 606 is one or more input/output (I/O) devices of the communications device 600. Examples of I/O devices include, but are not limited to, a microphone, a speaker, a camera, a touch screen, a keypad. I/O 606 enables a user to interact with the communications device 600 to communicate with the server 450 and/or appliance 420, i.e., via a phone call, text message, email, or videoconference. In some embodiments, I/O 606 also includes I/O interfaces that provide the communications device 600 with communications paths with other devices, such as other communications devices and peripherals.

The transceiver 608 provides a wireless communications capability with a network, such as network 460 in FIG. 4. Incoming signals are received by the transceiver 608 from the antenna 610 and processed by the receive (RX) circuity 612, which processes the signal and transmits the processed signal to an I/O device, such as a speaker, if the processed signal is for voice data. The processed signal can also be transmitted to the processor 604 for further processing before presentation to a user on another I/O device, such as a screen, if the processed signal is for other forms of data, such as web browsing data. Outgoing signals transmitted by the transceiver 608 from the antenna 610 are received from transmit (TX) circuitry 614. The TX circuitry 614 can receive voice data from a microphone, or other forms of outgoing data, such as web data, e-mail, or application data, from the processor 604.

The communications device 600 in FIG. 6 is depicted as a mobile phone, the communications device 600 can be any other conventional communications computing devices such as tablets, laptop computers, and desktop computers. For example, the transceiver depicted in the client device 600 can be replaced by a network communications interface that can support wired or wireless communication over a home network.

Moreover, for the purposes of the present disclosure, the term “a” or “an” entity refers to one or more of that entity. As such, the terms “a” or “an”, “one or more” and “at least one” can be used interchangeably herein.

All numeric values herein are assumed to be modified by the term “about”, whether or not explicitly indicated. For the purposes of the present invention, ranges may be expressed as from “about” one particular value to “about” another particular value. It will be understood that the endpoints of each of the ranges are significant both in relation to the other endpoint, and independently of the other endpoint. When a value is expressed as an approximation by use of the antecedent “about,” it will be understood that the particular value forms another embodiment.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. An apparatus for controlling a supply of power to an electrical device, the apparatus comprising:
an electrical flow path configured to be disposed between a source of electricity and an electrical subsystem of the electrical device, the electrical flow path configured to selectively provide a flow electricity from the source to the electrical subsystem based on a power switching message originating from a location remote from the electrical device;
a communication interface configured to receive the power switching message;
memory for storing instructions; and
a processor connected to the memory and the communication interface, wherein the processor is configured to execute the instructions to control the flow of electricity through the electrical path based on the power switching message.

2. The apparatus of claim 1, wherein the communications interface includes a subscriber identification module (SIM) card for communicating over telecommunications networks, and wherein the power switching message is a text message.

3. The apparatus of claim 1, further comprising
a first power connection interface at an upstream end of the electrical flow path configured to receive a first electrical connector electrically coupled to the source of electricity; and
a second power connection interface at a downstream end of the electrical flow path configured to receive a second electrical connector electrically coupled to the electrical subsystem of the electrical device.

4. The apparatus of claim 3, wherein the first power connection interface is configured to receive a female end of a C13 power cord, further wherein the second power connection interface is configured to receive a male end of an electrical power cord of the electrical device.

5. The apparatus of 4, wherein the apparatus further comprises a housing defining an enclosable chamber that houses the electrical flow path, the communications interface, the memory, and the processor.

6. The apparatus of claim 5, wherein the second power connection is housed within the enclosable chamber, further wherein the enclosable chamber is configured to prevent the removal of the male end of the electrical power cord of the electrical device when the enclosable chamber is sealed.

7. The apparatus of claim 5, wherein the processor is further configured to execute the instructions to cause the communications interface to transmit a notification in response to determining that the enclosable chamber has been breached.

8. An apparatus comprising:
an appliance comprising an electrical subsystem; and
a power control device comprising:
an electrical flow path disposed between a source of electricity and the electrical subsystem, wherein the electrical flow path is configured to selectively provide a flow electricity from the source to the electrical subsystem based on a power switching message originating from a location remote from the apparatus;
a communication interface configured to receive the power switching message;
memory for storing instructions; and
a processor connected to the memory and the communication interface, wherein the processor configured to execute the instructions to control the flow of electricity through the electrical path based on the power switching message.

9. The apparatus of claim 8, wherein the communications interface includes a subscriber identification module (SIM) card for communicating over telecommunications networks, and wherein the power switching message is a text message.

10. The apparatus of claim 8, wherein the power control device further comprises:
a first power connection interface at an upstream end of the electrical flow path configured to receive a first electrical connector electrically coupled to the source of electricity; and
a second power connection interface at a downstream end of the electrical flow path configured to receive a second electrical connector electrically coupled to the electrical subsystem of the electrical device.

11. The apparatus of claim 10, wherein the first power connection interface is configured to receive a female end of a C13 power cord, further wherein the second power connection interface is configured to receive a male end of an electrical power cord of the electrical device.

12. The apparatus of 11, wherein the power control device further comprises a housing defining an enclosable chamber that houses the electrical flow path, the communications interface, the memory, and the processor, further wherein the second power connection is housed within the enclosable chamber, and further wherein the enclosable chamber is configured to prevent the removal of the male end of the electrical power cord of the electrical device when the enclosable chamber is sealed.

13. The apparatus of claim 12, wherein the processor is further configured to execute the instructions to cause the communications interface to transmit a notification in response to determining that the enclosable chamber has been breached.

14. A system comprising:
an appliance comprising an electrical subsystem;
a power control device electrically coupled between the electrical subsystem of the appliance and a source of electricity, the power control device configured to selectively provide a flow electricity from the source to the electrical subsystem based on receiving a power switching message originating from a location remote from the appliance; and
a processor in communication with the power control device via a network, wherein the processor is configured to:
maintain a database comprising a customer payment status associated with the appliance; and
transmit a notification to a remote device when the customer payment status is delinquent.

15. The system of claim 14, wherein the processor is configured to transmit the notification within a threshold period of time of the customer payment status becoming delinquent.

16. The system of claim 14, wherein the threshold period of time is between 0 hours and 72 hours.

17. The system of claim 14, wherein the processor is further configured to receive a message from the remote device instructing the server to transmit the power switching message to the power control device to terminate the flow of electricity to the appliance.

18. The system of claim 17, wherein the processor is further configured to transmit a second notification to the remote device when the customer payment status is no longer delinquent.

19. The system of claim 18, wherein processor is further configured to receive a second message from the remote device instructing the server to transmit a second power switching message to the power control device to commence the flow of electricity to the appliance.

20. The system of claim 14, wherein the processor is further configured to transmit a second notification to the remote device in response to determining that an enclosable chamber of the power control device has been breached.
